(19) United States
(12) Patent Application Publication
(10) Pub. No.: US 2005/0287425 A1
(43) Pub. Date: Dec. 29, 2005

(54) Li/MnO2 battery separators with selective ion transport

(75) Inventors: Lie Shi, Charlotte, NC (US); Mark T. Demeuse, Charlotte, NC (US); Kevin D. Chambers, Fort Mill, SC (US)

Correspondence Address: ROBERT H. HAMMER III, P.C., 3125 SPRINGBANK LANE, SUITE G, CHARLOTTE, NC, 28226, US

(73) Assignee: Celgard Inc.

(21) Appl. No.: 10/877,958

(22) Filed: Jun. 25, 2004

(51) Int. Cl. H01M 2/14; H01M 2/16; H01M 6/14

(52) U.S. Cl. 429/145; 29/623.5; 429/303; 429/249

(57) ABSTRACT

A method for selectively blocking flow of manganese ions from manganese dioxide electrode to a lithium electrode in lithium-manganese dioxide cell comprising the steps of: providing a lithium electrode adapted to providing lithium ions; providing a manganese dioxide electrode adapted to providing manganese ions; and blocking flow of manganese ions from the manganese dioxide electrode to the lithium electrode but allow lithium ions to flow freely between the lithium electrode to the manganese dioxide electrode and back by; providing a battery separator between the manganese dioxide electrode and the lithium electrode where the separator selectively allow transport of lithium ions between the lithium electrode to the manganese dioxide electrode, but blocks flow of manganese ions from the manganese dioxide electrode to the lithium electrode.

### BACKGROUND OF THE INVENTION

To prolong the shelf life of Li-primary batteries made with cathodes from manganates, it is very desirable to use a battery separator that blocks Mn ion transport while allowing Li ions to transport through the separators. The invention here is to develop such a separator with selective ion transport coefficients.

In U.S. Pat. No. 6,322,923, the separator comprises a microporous membrane having a coating. The coating is made from a mixture of a gel forming polymer, a plasticizer, and a solvent. The solvent dissolves the gel forming polymer and the plasticizer so that the mixture may be easily and evenly applied to the membrane. Also, the solvent is relatively volatile, compared to the other components, so that it may be easily removed. The remaining coated separator (i.e., coating comprising gel forming polymer and plasticizer) is not porous and is not ready to be impregnated with electrolyte until it is made porous. The plasticizer is the pore-forming agent. The plasticizer, for example an ester-base phthalate or an organic carbonate, must be extracted to form the pores. This extraction step adds to the cost of the separator.

Pekala U.S. Pat. No. 5,586,138 teaches use of a PVDF coating on a UHMWPE polymer web. The PVDF coating is dissolved in solvent which allows the formation of a homogeneous solution. Exemplary solvents include ketones, chlorinated solvents, hydrocarbon solvents, acetates or carbonates.

Wensley US Publication Number U.S. 2002/0168564 A1 teaches a separator comprising a microporous membrane, a coating covering that membrane, the coating comprising a gel-forming polymer and a plasticizer in a weight ratio of 1:0.05 to 1:3.

The purpose of selectively blocking the transport of the Mn ions is to prolong the shelf-life of the battery. Presently, the shelf-life of the battery is related to chemical reactions which the Mn ions undergo when they are allowed to move. Thus, by blocking the transport of the Mn ions, the chemical reactions which are responsible for a shortened shelf-life in the battery would be reduced and/or eliminated and, hence, the shelf-life would increase.

### SUMMARY OF THE INVENTION

A method for selectively blocking flow of manganese ions from manganese dioxide electrode to a lithium electrode in lithium-manganese dioxide cell comprising the steps of: providing a lithium electrode adapted to providing lithium ions; providing a manganese dioxide electrode adapted to providing manganese ions; and blocking flow of manganese ions from the manganese dioxide electrode to the lithium electrode but allow lithium ions to flow freely between the lithium electrode to the manganese dioxide electrode and back by; providing a battery separator between the manganese dioxide electrode and the lithium electrode where the separator selectively allow transport of lithium ions between the lithium electrode to the manganese dioxide electrode, but blocks flow of manganese ions from the manganese dioxide electrode to the lithium electrode.

The battery separator for a lithium cell capable of selectively transporting Li ions through the battery separator while blocking Mn ions, comprising the steps of: providing a microporous membrane where the microporous membrane is a polyolefin and the polyolefin is selected from the group consisting of: polyethylenes, polypropylenes, polybutylenes, and polymethyl pentenes; providing a gel-forming polymer solution comprising a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; and an organic solvent having a boiling point of less than 80 degrees centigrade; providing a second solvent having a boiling point of at least 60 degrees centigrade, the first solvent being more volatile than the second solvent, and the second solvent adapted to form pores in the gel-forming polymer; mixing the gel-forming polymer solution with the second solvent to form a gel-forming polymer and solution mixture; coating the microporous membrane with the gel-forming polymer and solution mixture; and drying the microporous membrane to form a separator.

A battery separator for a lithium cell capable of selectively transporting Li ions through the battery separator while blocking Mn ions, comprising: a microporous polyolefin membrane; and a coating thereon, the coating being a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; where the battery separator has a Gurley value in the range of 20 to 110 seconds/10 cc according to ASTM D-726(B).

### DESCRIPTION OF THE DRAWINGS

FIG. 1 is a cross sectional view of a battery separator for a lithium cell capable of selectively transporting Li ions through the battery separator while blocking Mn ions.

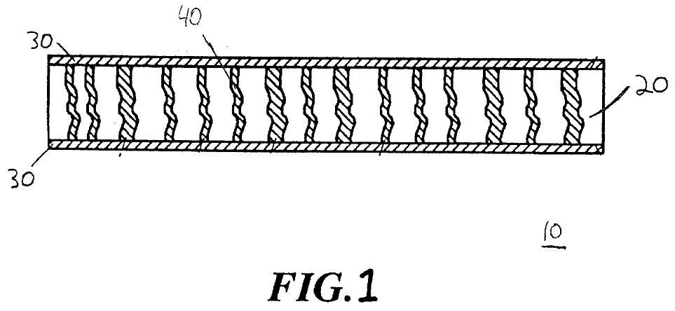

### DETAILED DESCRIPTION OF THE INVENTION

To prolong the shelf life of Li-primary batteries made with cathodes from manganates, it is very desirable to use a battery separator that blocks Mn ion transport while allowing Li ions to transport through the separators. The invention here is to develop such a separator with selective ion transport coefficients. The separator includes the following variation:
Dense to porous gel forming polymer coating, at various thicknesses, onto microporous polyolefin separators
   By controlling the density of the gel forming polymer coating or the gel forming copolymer and controlling the concentration and evaporation rate of solvent and/or plasticizers, a proper balance of the ion-transport coefficients can be obtained. Also, by varying the thickness of the gel forming polymer coating on a polyolefin separator, it is possible to control the relative rate of the transport of various ions.

A battery separator 10 for a lithium cell capable of selectively transporting Li ions through the battery separator while blocking Mn ions, comprising: a microporous polyolefin membrane 20; and a coating thereon 30, the coating being a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; where the battery separator has a Gurley value in the range of 20 to 110 seconds/10 cc according to ASTM D-726(B). Gurley is a resistance to air flow measured by the Gurley densometer (e.g. Model 4120). Gurley is the time in seconds required to pass 10 cc of air through one square inch of product under a pressure of 12.2 inches of water.

Microporous membrane 20 refers to any microporous membrane. Membrane 20 may be made from polyolefins. Exemplary polyolefins include, but are not limited to, polyethylene (PE), polypropylene (PP), polymethylpentene (PMP) and polybutylenes (PB). Membrane 20 may be made by either a dry stretch process (also known as the CELGARD process) or a solvent process (also known as the gel extrusion or phase separation process). Other processes for the preparation of membranes include: phase inversion process; wet process and a particle stretch process. Membrane 20 may have the following characteristics: an air permeability of no more than 125 sec/10 cc (preferably 50 sec/10 cc, most preferably 20 sec/10 cc); a thickness ranging from 5 to 500 μm (preferably 10 to 100 μm, most preferably 10 to 50 μm); pore diameters ranging from 0.001 to 10 μm (preferably 0.01 to 5 μm, most preferably 0.02 to 0.5 μm); and a porosity ranging from 35 to 85% (preferably 40 to 80%). Membrane 20 is preferably a shut down separator, for example see U.S. Pat. Nos. 4,650,730; 4,731,304; 5,281,491; 5,240,655; 5,565,281; 5,667,911; 5,952,120; Japanese Patent No. 2642206 and Japanese Patent Application Nos. 98395/1994 (filed May 12, 1994); 7/56320 (filed Mar. 15, 1995); and U.K. Patent Application No. 9604055.5 (Feb. 27, 1996), which are incorporated herein by reference. Membranes 20 are commercially available from: CELGARD LLC, Charlotte, N.C., USA; Asahi Chemical Industry Co., Ltd., Tokyo, Japan; Tonaen Corporation, Tokyo, Japan; Ube Industries, Tokyo, Japan; and Nitto Denko K. K., Osaka, Japan.

The membrane 20 can be either a single layer or a multilayer separator. The most common single layer separator is a polyethylene separator. In the multilayer separators one example is a tri-layer being made up of a polypropylene layer, a polyethylene layer and a polypropylene layer. These microporous polyolefin membranes generally have an overall thickness of 50 μm or less. Preferably the overall thickness is 25 μm or less.

The coating 30 is applied to a surface of membrane 20, preferably both the exterior surface-and pore 40 interior surfaces. The coating is applied to a surface density of less than 0.6 mg/cm², preferably in a range of 0.10 to 0.4 mg/cm². To optimize performance it has been found that coatings in the range of 0.2 to 0.3 mg/cm² work well. Coating 30 may be applied to membrane 20 in the form of a dilute solution of a gel-forming polymer and a solvent. Coating 30, to achieve suitable adhesion, should have a surf ace density in the range of less than 0.3 mg/cm² (preferably in the range of 0.05 to less than 0.3 mg/cm²; and most prefer ably 0.1 to 0.25 mg/cm²). The first solvent is chosen so that it can dissolve or suspend the gel forming polymer. Organic solvents having a boiling point of less than 80 degrees centigrade are selected as the first solvent. Exemplary solvents include, but are not limited to tetrahydrofuran, methyl ethyl ketone (MEK), dimethyl ether, ethylene oxide, propylene oxide and acetone. The preferred first solvent is acetone. The dilute solution may contain less than 10% by weight of the gel forming polymer.

The second solvent is the pore former for the gel-forming polymer. The first solvent is more volatile than the second solvent (e.g., the second solvent has a lower vapor pressure than the first solvent). Exemplary second solvents include, but are not limited to, organic solvents, e.g., tetrahydrofuran, methyl ethyl ketone (MEK), methanol, ethanol, 1-propanol, 2-propanol, butanol and 2-pentanol. In addition to the second solvent, some water may be added. Preferably that water would be deionizer water. If water is used in conjunction with the second solvent it may also be preferred to use a hydrophilic solvent. In this context we use the term hydrophilic to mean a solvent which will dissolve or mix readily with water and not separate out into two discreet phases.

Battery separators according to the present invention have a Gurley value in the range of 20 to 110 seconds/10 cc, preferably 22 to 95 seconds/10 cc, according to ASTM-D726(B).

A method for selectively blocking flow of manganese ions from manganese dioxide electrode to a lithium electrode in lithium-manganese dioxide cell comprising the steps of: providing a lithium electrode adapted to providing lithium ions; providing a manganese dioxide electrode adapted to providing manganese ions; and blocking flow of manganese ions from the manganese dioxide electrode to the lithium electrode but allow lithium ions to flow freely between the lithium electrode to the manganese dioxide electrode and back by; providing a battery separator between the manganese dioxide electrode and the lithium electrode where the separator selectively allows transport of lithium ions between the lithium electrode to the manganese dioxide electrode, but block a flow of manganese ions from the manganese dioxide electrode to the lithium electrode. While not being bound to any particular theory, it is believed that the films of the present invention prevent the passage of Mn ions by creating a tortuous path for their movement. This tortuous path impedes the transport of Mn ions through the film while allowing Li ions to pass freely through the film.

The battery separator of the present invention is made by the process, which comprises the steps of: providing a microporous membrane where the microporous membrane is a polyolefin and the polyolefin is selected from the group consisting of: polyethylenes, polypropylenes, polybutylenes, and polymethyl pentenes; providing a gel-forming polymer solution comprising a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; and a first organic solvent having a boiling point of less than 80 degrees centigrade; providing a second solvent where the second solvent has a boiling point of at least 60 degrees centigrade and, the first solvent being more volatile than the second solvent, and the second solvent adapted to form pores in the gel-forming polymer; mixing the gel-forming polymer solution with the second solvent to form a gel-forming polymer and solution mixture; coating the microporous membrane with the gel-forming polymer and solution mixture; and drying the microporous membrane to form a separator.

In this process for making a battery separator for a lithium cell, the gel-forming polymer solution is provided in a ratio of 1% to 10% polymer to organic solvent. When water is added to the second solvent, the water to second solvent ratio is in the range of 0.25:1 to 2:1, preferably 0.5:1.

A preferred gel-forming polymer is a poly(vinylidene fluoride:hexafluoropropylene) (PVDF:HFP) copolymer. The most preferred copolymer is PVDF:HFP with a weight ratio of 91:9. The PVDF copolymers are commercially available from Atochem, Philadelphia, Pa., USA, Solvay SA, Brussels, Belgium, and Kureha Chemicals Industries, Ltd., Ibaraki, Japan. A preferred PVDF:HFP copolymer is KYNAR 2800 from Atochem.

The microporous polyolefin membrane is produced by a process selected from: dry-stretch process; wet process; phase inversion process; or by a particle stretch process. Preferred microporous polyolefin membranes have a thickness of 25 μm or less.

Alternatively the battery separator can be made by the process comprising the steps of: providing a microporous membrane where the microporous membrane is a polyolefin and the polyolefin is selected from the group consisting of: polyethylenes, polypropylenes, polybutylenes, and polymethyl pentenes; providing a gel-forming polymer solution comprising a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; and an organic solvent having a boiling point of less than 80 degrees centigrade; mixing the gel-forming polymer solution with the solvent to form a gel-forming polymer and solution mixture; coating at least one side of the microporous membrane with the gel-forming polymer and solution mixture; and drying the microporous membrane to form a battery separator.

### EXAMPLES

(A) Sample and Sample Preparation Description:

All samples have a PVDF copolymer concentration in acetone of 2.5% polymer. The PVDF copolymer used is Kynar FLEX 2800 from AtoFina Chemicals, Inc., Philadelphia, Pa. The ratio of water to IPA in the non-solvent mixture is 1:2. Dewpoint is 38 F. Three hand sheets of a trilayer film, designated AC25 from Celgard, were coated at each of the following conditions:
(1) PVDF coated only. No IPA/water added.
(2) PVDF/IPA+water at 1:0.5 ratio.
(3) PVDF/IPA+water at 1:1 ratio.

(B) Characterization Data:

| | | | Add-on | Ave. Pore Size |
|---|---|---|---|---|
| Condition # | Gurley (sec) | ER | (mg/cm2) | (microns) |
| 1 | 117.3 | 15.1 | 0.27 | 0.032 |
| | STD = 31.0 | | | STD = 0.003 |
| 2 | 66.0 | 12.5 | 0.25 | 0.035 |
| | STD = 6.1 | | | STD = 0.001 |
| 3 | 43.3 | 11.2 | 0.20 | 0.036 |
| | STD = 3.3 | | | STD = 0.001 |

Gurley values are the average of 4 separate measurements.
Average pore size measurements are the average of three separate measurements. Tests were conducted using the fluorinert method, an internal Celgard test.
Electrical resistance, ER, is specified as McMullin Number, which is defined as the ratio of the electrical resistance of an electrolyte-saturated porous medium to the resistance of an equivalent volume of electrolyte.

1. A method for selectively blocking flow of manganese ions from manganese dioxide electrode to a lithium electrode in lithium-manganese dioxide cell comprising the steps of:
providing a lithium electrode adapted to providing lithium ions;
providing a manganese dioxide electrode adapted to providing manganese ions; and
blocking flow of manganese ions from said manganese dioxide electrode to said lithium electrode but allow lithium ions to flow freely between the lithium electrode to the manganese dioxide electrode and back by;
providing a battery separator between said manganese dioxide electrode and said lithium electrode where said separator selectively allows transport of lithium ions between said lithium electrode to said manganese dioxide electrode, but block a flow of manganese ions from said manganese dioxide electrode to the lithium electrode.

2. The method for blocking flow of manganese ions from a manganese dioxide electrode to a lithium electrode in lithium-manganese dioxide cell according to claim 1 where said battery separator is made by a process comprising the steps of:
providing a microporous membrane where said microporous membrane is a polyolefin and said polyolefin is selected from the group consisting of: polyethylenes, polypropylenes, polybutylenes, and polymethyl pentenes
providing a gel-forming polymer solution comprising a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; and a first organic solvent having a boiling point of less than 80 degrees centigrade;
providing a second solvent where said second solvent has a boiling point of at least 60 degrees centigrade, said first solvent being more volatile than said second solvent, and said second solvent adapted to form pores in the gel-forming polymer;
mixing said gel-forming polymer solution with said second solvent to form a gel-forming polymer and solution mixture;
coating at least one side of said microporous membrane with said gel-forming polymer and solution mixture; and
drying the microporous membrane to form a battery separator.

3. The method for blocking flow of manganese ions from a manganese dioxide electrode to a lithium electrode in lithium-manganese dioxide cell according to claim 2 where said battery separator has a Gurley value in the range of 20 to 110 seconds/10 cc as measured by ASTM D-726 (B).

4. The method for blocking flow of manganese ions from a manganese dioxide electrode to a lithium electrode in lithium-manganese dioxide cell according to claim 2 where said second solvent is mixed with water.

5. The method for blocking flow of manganese ions from a manganese dioxide electrode to a lithium electrode in lithium-manganese dioxide cell according to claim 2 where said gel-forming polymer solution is provided in a ratio of 1% to 10% polymer to organic solvent.

6. The method for blocking flow of manganese ions from a manganese dioxide electrode to a lithium electrode in lithium-manganese dioxide cell according to claim 4 where said second solvent is provided in a ratio of from 1:2 to 3:5 water to second solvent.

7. The method for blocking flow of manganese ions from a manganese dioxide electrode to a lithium electrode in lithium-manganese dioxide cell according to claim 6 having a ratio of gel-forming polymer to second solvent in a ratio of 3:1 to 1:3 gel-forming polymer to second solvent.

8. The method for blocking flow of manganese ions from a manganese dioxide electrode to a lithium electrode in lithium-manganese dioxide cell according to claim 2 where said gel-forming polymer is a poly(vinylidene fluoride:hexafluoropropylene) copolymer.

9. The method for blocking flow of manganese ions from a manganese dioxide electrode to a lithium electrode in lithium-manganese dioxide cell according to claim 2 where said microporous polyolefin membrane is produced by a process selected from: dry-stretch process; wet process; phase inversion process; or by a particle stretch process.

10. The method for blocking flow of manganese ions from a manganese dioxide electrode to a lithium electrode in lithium-manganese dioxide cell according to claim 2 where said microporous polyolefin membrane has a thickness of 25 μm or less.

11. The method for blocking flow of manganese ions from a manganese dioxide electrode to a lithium electrode in lithium-manganese dioxide cell according to claim 2 where said battery separator has pore diameters ranging from 0.01 to 5 μm.

12. The method for blocking flow of manganese ions from a manganese dioxide electrode to a lithium electrode in lithium-manganese dioxide cell according to claim 1 where said battery separator is made by a process comprising the steps of:
providing a microporous membrane where said microporous membrane is a polyolefin and said polyolefin is selected from the group consisting of: polyethylenes, polypropylenes, polybutylenes, and polymethyl pentenes
providing a gel-forming polymer solution comprising a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; and an organic solvent having a boiling point of less than 80 degrees centigrade;
mixing said gel-forming polymer solution with said solvent to form a gel-forming polymer and solution mixture;
coating at least one side of said microporous membrane with said gel-forming polymer and solution mixture; and
drying the microporous membrane to form a battery separator.

13. The method for blocking flow of manganese ions from a manganese dioxide electrode to a lithium electrode in lithium-manganese dioxide cell according to claim 1 where said battery separator is made by a process comprising the steps of:
providing a microporous membrane where said microporous membrane is a polyolefin and said polyolefin is selected from the group consisting of: polyethylenes, polypropylenes, polybutylenes, and polymethyl pentenes
providing a gel-forming polymer solution comprising a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; and a first organic solvent having a boiling point of less than 80 degrees centigrade;
providing a second solvent where said second solvent has a boiling point of at least 60 degrees centigrade, said first solvent being more volatile than said second solvent, and said second solvent adapted to form pores in the gel-forming polymer;
mixing said gel-forming polymer solution with said second solvent to form a gel-forming polymer and solution mixture;
coating at least one side of said microporous membrane with said gel-forming polymer and solution mixture;
drying the microporous membrane to form a battery separator where said battery separator separator has a Gurley value in the range of 20 to 110 seconds/10 cc as measured by ASTM D-726 (B).

14. The method for blocking flow of manganese ions from a manganese dioxide electrode to a lithium electrode in lithium-manganese dioxide cell according to claim 1 where said battery separator is made by a process comprising the steps of:
providing a microporous membrane where said microporous membrane is a polyolefin and said polyolefin is selected from the group consisting of: polyethylenes, polypropylenes, polybutylenes, and polymethyl pentenes
providing a gel-forming polymer solution comprising a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; and a first organic solvent having a boiling point of less than 80 degrees centigrade;
providing a second solvent where said second solvent has a boiling point of at least 60 degrees centigrade, said first solvent being more volatile than said second solvent, and said second solvent adapted to form pores in the gel-forming polymer;
mixing said gel-forming polymer solution with said second solvent to form a gel-forming polymer and solution mixture;
coating at least one side of said microporous membrane with said gel-forming polymer and solution mixture;
drying the microporous membrane to form a battery separator where said battery separator has pore diameters ranging from 0.01 to 5 μm.

15. The method for blocking flow of manganese ions from a manganese dioxide electrode to a lithium electrode in lithium-manganese dioxide cell according to claim 2 where said battery separator has a Gurley value in the range of 22 to 95 seconds/10 cc as measured by ASTM D-726 (B).

16. A method for selectively blocking flow of manganese ions from manganese dioxide electrode to a lithium electrode in lithium-manganese dioxide cell comprising the steps of:
providing a lithium electrode adapted to providing lithium ions;
providing a manganese dioxide electrode adapted to providing manganese ions; and
blocking flow of manganese ions from said manganese dioxide electrode to said lithium electrode but allow lithium ions to flow freely between the lithium electrode to the manganese dioxide electrode and back with a battery separator between said manganese dioxide electrode and said lithium electrode where said separator selectively allows transport of lithium ions between said lithium electrode to said manganese dioxide electrode, and blocks flow of manganese ions from said manganese dioxide electrode to the lithium electrode where said battery separator is made by a process comprising the steps of:
providing a microporous membrane where said microporous membrane is a polyolefin and said polyolefin is selected from the group consisting of: polyethylenes, polypropylenes, polybutylenes, and polymethyl pentenes
providing a gel-forming polymer solution comprising a gel-forming polymer selected from the group consisting of: polyvinylidene fluoride, polyurethane, polyethyleneoxide, polyacrylonitrile, polymethylacrylate, polyacrylamide, polyvinylacetate, polyvinylpyrrolidone, polytetraethylene glycol diacrylate, copolymers of any of the foregoing, and combinations thereof; and a first organic solvent having a boiling point of less than 80 degrees centigrade;
providing a second solvent where said second solvent has a boiling point of at least 60 degrees centigrade, said first solvent being more volatile than said second solvent, and said second solvent adapted to form pores in the gel-forming polymer;
mixing said gel-forming polymer solution with said second solvent to form a gel-forming polymer and solution mixture;
coating at least one side of said microporous membrane with said gel-forming polymer and solution mixture; and
drying the microporous membrane to form a battery separator which has a Gurley value in the range of 20 to 110 seconds/10 cc as measured by ASTM D-726 (B).
